(19) United States
(12) Patent Application Publication
(10) Pub. No.: US 2016/0274477 A1
(43) Pub. Date: Sep. 22, 2016

(54) TWO-COMPONENT DEVELOPER, DEVELOPMENT DEVICE AND IMAGE FORMATION APPARATUS

(71) Applicant: Oki Data Corporation, Tokyo (JP)

(72) Inventor: Junichi NAKAGAWA, Tokyo (JP)

(73) Assignee: Oki Data Corporation, Tokyo (JP)

(21) Appl. No.: 15/042,224

(22) Filed: Feb. 12, 2016

(30) Foreign Application Priority Data
Mar. 19, 2015 (JP) 2015-056985

(51) Int. Cl. G03G 9/00

(52) U.S. Cl. CPC G03G 9/0821; G03G 9/1132

(57) ABSTRACT

A two-component developer includes a toner and carriers. A softening temperature of the toner in a ½ method test is not less than 106° C. but is less than 112° C., surface free energy of resin coating layers of the carriers is set at 12 mN/m. If the toner softening temperature in the ½ method test is not less than 112° C. but is less than 115° C., the surface free energy is set at not greater than 15 mN/m. If the toner softening temperature in the ½ method test is not less than 115° C. but is less than 126° C., the surface free energy is set at not greater than 20 mN/m. If the toner softening temperature in the ½ method test is not less than 126° C. but not greater than 130° C., the surface free energy is set at not greater than 40 mN/m.

### CROSS REFERENCE TO RELATED APPLICATIONS

This application claims priority based on 35 USC 119 from prior Japanese Patent Application No. 2015-056985 filed on Mar. 19, 2015, entitled “TWO-COMPONENT DEVELOPER, DEVELOPMENT DEVICE AND IMAGE FORMATION APPARATUS”, the entire contents of which are incorporated herein by reference.

### BACKGROUND OF THE INVENTION

1. Field of the Invention

This disclosure relates to an electrophotographic image formation apparatus such as a printer or copy machine, and a development device for the image formation apparatus. Particularly, this disclosure relates to a two-component developer to be used in the development by the development device.

2. Description of Related Art

A conventional image formation apparatus uses a two-component developer made of a toner and carriers, and inhibits density unevenness of the two-component developer during the development of an image on a photosensitive drum with surface free energy of the carriers taken into consideration (see Document 1, for example).

[Document 1] Japanese Patent Application Publication No. 2006-162842 (Paragraphs 0009 to 0010)

### SUMMARY OF THE INVENTION

When using a toner whose softening temperature in a ½ method test is low, however, the two-component developer may have a problem that the toner tends to adhere to the carriers when the surface free energy of the carriers is high.

A first aspect of the invention is a two-component developer that includes a toner and carriers. In a condition where the softening temperature of the toner in a ½ method test is not less than 106° C. but is less than 112° C., surface free energy of the resin coating layers of the carriers is set at 12 mN/m. In a condition where the softening temperature of the toner in the ½ method test is not less than 112° C. but is less than 115° C., the surface free energy of the resin coating layers of the carriers is set at not greater than 15 mN/m. In a condition where the softening temperature of the toner in the ½ method test is not less than 115° C. but is less than 126° C., the surface free energy of the resin coating layers of the carriers is set at not greater than 20 mN/m. In a condition where the softening temperature of the toner in the ½ method test is not less than 126° C. but not greater than 130° C., the surface free energy of the resin coating layers of the carriers is set at not greater than 40 mN/m.

A second aspect of the invention is a two-component developer that includes a toner and carriers, wherein lower and upper limits of a softening temperature of the toner in the ½ method test are 106° C. and 130° C., respectively, and wherein lower and upper limits of a surface free energy of resin coating layers of the carriers are 12 mN/m and 40 mN/m, respectively.

The above aspects of the invention make it possible to inhibit the toner from adhering to the carriers.

### BRIEF DESCRIPTION OF THE DRAWINGS

FIG. 1 is an explanatory diagram illustrating a printer of an embodiment.

FIG. 2 is an explanatory diagram illustrating a development device of the embodiment.

FIG. 3 is a block diagram illustrating a control system of the printer of the embodiment.

FIG. 4 is an explanatory diagram illustrating a print pattern used in an evaluation test of the embodiment.

FIG. 5 is an explanatory diagram illustrating a result of the evaluation test of the embodiment.

### DETAILED DESCRIPTION OF EMBODIMENTS

Descriptions are provided hereinbelow for embodiments based on the drawings. In the respective drawings referenced herein, the same constituents are designated by the same reference numerals and duplicate explanation concerning the same constituents is omitted. All of the drawings are provided to illustrate the respective examples only.

Referring to the drawings, descriptions are hereinbelow provided for an embodiment of a two-component developer, a development device and an image formation apparatus of the invention.

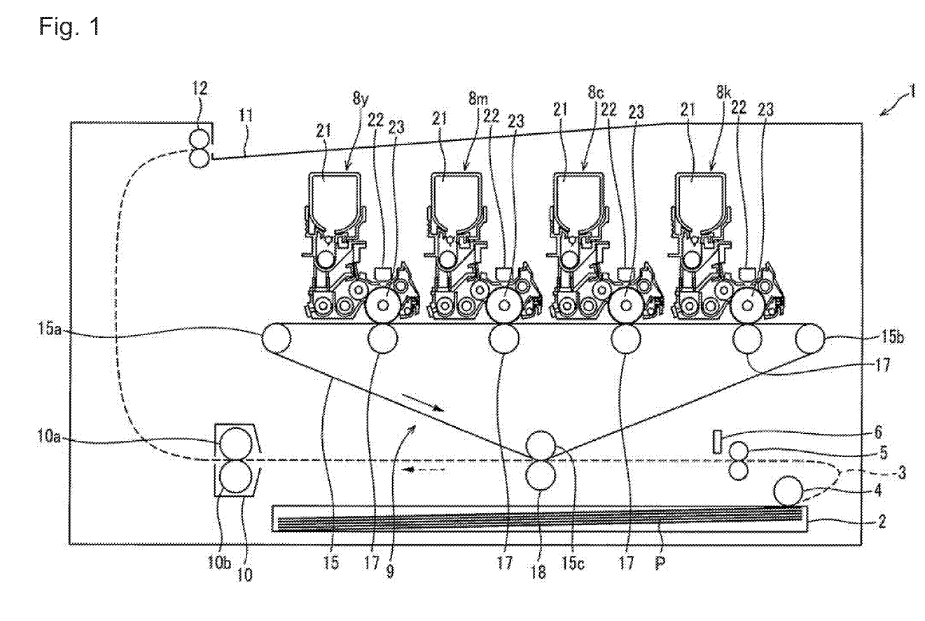

Using FIGS. 1 to 5, descriptions are hereinbelow provided for a printer of the embodiment.

Printer 1 as the image formation apparatus of the embodiment is an electrophotographic color printer configured to print color images.

As illustrated in FIG. 1, printer 1 includes: sheet cassette 2 detachably attached to a lower portion of an apparatus housing, and housing sheets P as print media in a stacked condition; hopping roller 4 configured to, by its rotation, send out sheets P housed in sheet cassette 2 separately on a one-by-one basis onto sheet transport path 3 as indicated with a dashed line in FIG. 1; transport rollers 5 configured to transport each sheet P along sheet transport path 3; sheet position detection sensor 6 configured to detect the leading edge of sheet P which is transported in a sheet transport direction indicated with a dashed arrow in FIG. 1; development devices 8 configured to form their respective colors' toner images; transfer unit 9 configured to transfer the toner images, which are formed by development devices 8, onto sheet P; fixation unit 10 configured to fix the toner images, which are transferred onto sheet P by transfer unit 9, onto sheet P by pressure and heat respectively provided by heat roller 10a and pressure roller 10b; and delivery rollers 12 configured to deliver sheet P, onto which the toner images are fixed by fixation unit 10, onto stacker 11.

Transfer unit 9 includes: endless intermediate transfer belt 15 suspended by drive roller 15a, support roller 15b and support roller 15c, and functioning as a transfer body onto which to transfer the toner images; primary transfer roller 17 as a transfer member; secondary transfer roller 18 as a transfer member placed opposite support roller 15c; and a cleaning member, albeit not illustrated, configured to remove toners which remain on intermediate transfer belt 15 after the transfer onto sheet P by secondary transfer roller 18.

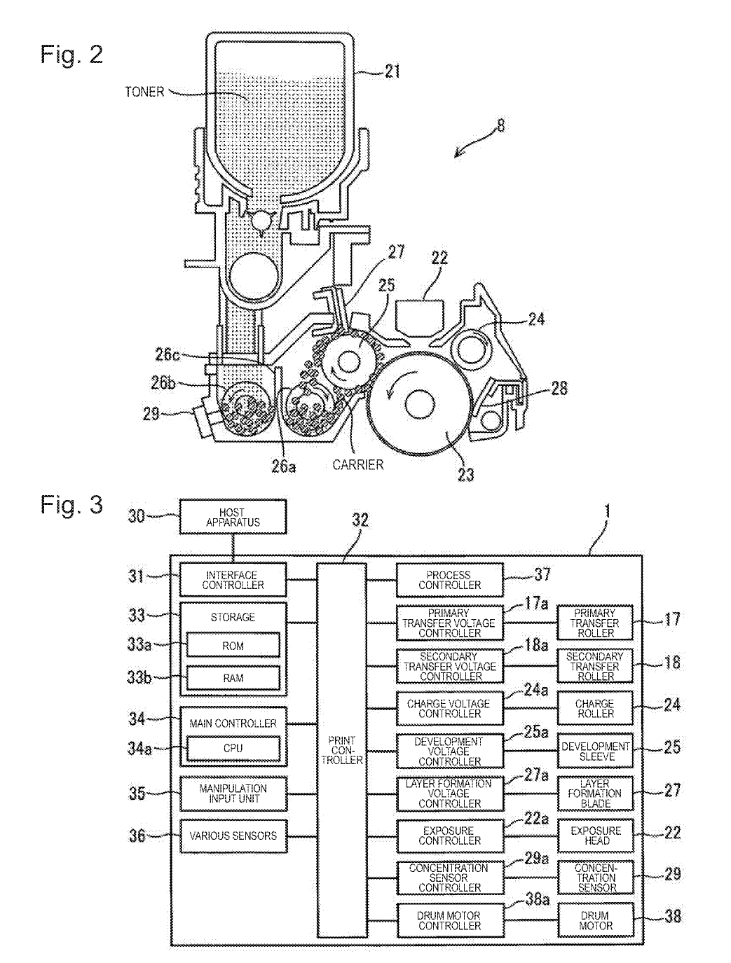

Printer 1 of the embodiment uses two-component developers (hereinafter simply referred to as “developers”) each obtained by mixing a toner as a first developer component material, and magnetic carriers which are magnetic globes (hatched globes in FIG. 2, and hereinafter simply referred to as “carriers”) as a second developer component material, in a predetermined ratio.

Development devices 8 respectively include toner tanks 21 configured to contain toners corresponding to colors, that is to say, black (K), yellow (Y), magenta (M) and cyan (C), which are set for development devices 8. Four development devices 8k, 8y, 8m, 8c are arranged in the order of the formation of their respective toner images on intermediate belt 15 rotationally driven by drive roller 15a.

Furthermore, as illustrated in FIG. 2, each development device 8 includes: exposure head 22 as an exposure member; photosensitive drum 23, as an image carrier, on which an electrostatic latent image is formed by an exposure made by exposure head 22; charge roller 24, as a charge member, configured to evenly charge the surface of photosensitive drum 23; development sleeve 25, as development member or a toner carrier, configured to develop the electrostatic latent image by supplying the toner to photosensitive drum 23 on which the electrostatic latent image is formed; first and second transport screws 26a, 26b, as developer supply members, configured to supply the developer made of the toner and the carriers to development sleeve 25 while agitating the developer; layer formation blade 27, as a developer layer formation member, configured to form a developer layer with a predetermined thickness by controlling the developer on an outer peripheral surface of development sleeve 25; cleaning blade 28, as an image carrier cleaning member, configured to scrape and thereby remove the toner which remains on photosensitive drum after the transfer onto intermediate transfer belt 15; concentration sensor 29, as a toner concentration detection member, configured to detect the toner concentration while the toner is being developed.

As illustrated in FIG. 3, a control system of printer 1 of the embodiment includes: interface controller 31 configured to receive print data and control instructions from host apparatus 30 as an information input member, such as a personal computer; print controller 32 configured to control the print operation of printer 1 based on the print data and the control instructions received by interface controller 31; storage 33; main controller 34; manipulation input unit 35; and various sensors 36.

The control system further includes: primary transfer voltage controller 17a configured to control a primary transfer voltage to be applied to each primary transfer roller 17; secondary transfer voltage controller 18a configured to control a secondary transfer voltage to be applied to secondary transfer roller 18; charge voltage controller 24a configured to control a charge voltage to be applied to each charge roller 24; development voltage controller 25a configured to control a development voltage to be applied to each development sleeve 25; layer formation voltage controller 27a configured to control a layer formation voltage to be applied to each layer formation blade 27; and process controller 37 configured to control the timing of applying voltages to be applied by the above-mentioned voltage controllers based on instructions from print controller 32.

The control system further includes: exposure controller 22a configured to control light emission from each exposure head 22 based on the print data; concentration sensor controller 29a configured to control an adjustment voltage for adjusting the sensitivity of each concentration sensor 29, and the like; and drum motor controller 38a configured to control the drive of drum motor 38 for rotationally driving each photosensitive drum 23.

It should be noted that interface controller 31, storage 33, main controller 34, manipulation input unit 35 and various sensors 36 are connected to print controller 32, and output signals mainly to print controller 32; and primary transfer voltage controller 17a, secondary transfer voltage controller 18a, charge voltage controller 24a, development voltage controller 25a, layer formation voltage controller 27a, process controller 37, exposure controller 22a, concentration sensor controller 29a and drum motor controller 38a are connected to print controller 32, and operate based on signals outputted from the print controller.

Primary transfer rollers 17 are placed opposite photosensitive drums 23 of development devices 8, respectively, with intermediate transfer belt 15 interposed in between. Primary transfer rollers 17 respectively transfer the toner images, which are formed on photosensitive drums 23, onto the outer peripheral surface of intermediate transfer belt 15 using the primary transfer voltages applied by primary transfer voltage controller 17a to primary transfer rollers 17. Intermediate transfer belt 15 is rotationally driven by drive roller 15a in an arrow direction (referred to as a “toner image transport direction”) as indicated with a solid line in FIG. 1. Intermediate transfer belt 15 carriers the toner images, which are transferred by primary transfer rollers 17 from photosensitive drums 23 of development devices 8k, 8y, 8m, 8c onto intermediate transfer belt 15, toward secondary transfer roller 18.

Secondary transfer roller 18 is placed opposite support roller 15c with intermediate transfer belt 15 interposed in between. Secondary transfer roller 18 transfers the toner images, which are transferred onto intermediate transfer belt 15, onto sheet P transported in the sheet transport direction while held between intermediate transfer belt 15 and secondary transfer roller 18, using the secondary transfer voltage applied by secondary transfer voltage controller 18a to secondary transfer roller 18.

Exposure heads 22 are respectively placed above and opposite to photosensitive drums 23 of the respective development devices 8, and each includes a light emission body such as an LED (Light Emitting Diode) or a laser. In accordance with light emission signals from exposure controller 22a to exposure heads 22 based on the print data, exposure heads 22 selectively emit light onto the surface of photosensitive drums 23, thus exposing the surface thereof to the light, and thereby forming the respective electrostatic latent images.

Each photosensitive drum 23 is rotationally driven by the drive of drum motor 38 in accordance with drum motor controller 38a in a direction of the transport of sheet P (the counterclockwise direction indicated with an arrow in FIG. 2, and referred to as a “transport rotation direction”).

A gear provided to an axial end portion of the photosensitive drum 23 is in mesh with gears provided to end portions of development sleeve 25 and first and second transport screws 26a, 26b corresponding to photosensitive drum 23. The gears are rotationally driven by drum motor 38 in their respective arrow directions illustrated in FIG. 2.

Each charge roller 24 is a column-shaped member obtained by forming an epichlorohydrin rubber layer on the outer periphery of a metal-made shaft, and rotates in a direction opposite to the rotation of photosensitive drum 23 corresponding to charge roller 24. Charge roller 24 evenly charges the outer peripheral surface of photosensitive drum 23 using the charge voltage applied by charge voltage controller 24a to charge roller 24.

First and second transport screws 26a, 26b are shaft-shaped members rotating in directions opposite to each other, with each having a spiral blade provided to its outer peripheral surface. First transport screw 26a, placed opposite development sleeve 25, and second transport screw 26b are placed next to each other across projection wall 26c. Projection wall 26c has cut portions, albeit not illustrated, provided to its two axial end portions. First and second transport screws 26a, 26b transport the toner supplied from toner tank 21 and the carriers filled in advance in their respective axial directions while agitating the toner and the carriers by the rotation of the spiral blades.

The toner of the embodiment accumulates on and around the second transport screw 26b side via a supply hole, albeit not illustrated, provided to an axial end portion of second transport screw 26b. The toner is transported, for example from the front to rear sides in a sheet on which FIG. 2 is drawn, while being agitated with the carriers by second transport screw 26b, and moves to the first transport screw 26a side after getting over the cut portion of projection wall 26c on the rear side. After moving to the first transport screw 26a side, the developer is transported from the rear to the front sides while being agitated by first transport screw 26a. The thus-transported developer is returned to the second transport screw 26b side after getting over the cut portion of projection wall 26c on the front side, and goes into circulation.

The agitation of the toner and the carriers by first and second transport screws 26a, 26b makes the toner and the carriers rub together. The friction between the toner and the carriers charges the toner of the embodiment negatively, and the carriers of the embodiment positively.

Development sleeve 25 is a cylinder-shaped member obtained by providing a magnetic body inside a metal-made pipe, and is opposite photosensitive drum 23 with a predetermined clearance (450 μm, in the embodiment) in between. Using its magnetic force, development sleeve 25 draws up the developer agitated by first and second transport screws 26a, 26b, and thereby forms magnetic brushes on the outer peripheral surface of development sleeve 25. Depending on the development voltage applied to development sleeve 25 by development voltage controller 25a, development sleeve 25 makes the toner adhere to the electrostatic latent image formed on photosensitive drum 23, and develops the electrostatic latent image.

In the embodiment, the electrostatic latent image is developed by making only the toner move from the magnetic brushes to photosensitive drums 23 by use of an electric force, with the carriers in the magnetic brushes remaining on the outer peripheral surface of development sleeve 25 by the carriers being attracted by the magnetic force.

Each layer formation blade 27 is a plate-shaped member configured to restrict the magnetic brushes formed on development sleeve 25 to have a certain length by use of the layer formation voltage applied to layer formation blade 27 by layer formation voltage controller 27a. Layer formation blade 27 is placed opposite to the outer peripheral surface of development sleeve 25 with a predetermined clearance (450 μm, in the embodiment) between the tip end of layer formation blade 27 and the outer peripheral surface of development sleeve 25.

Each concentration sensor 29 is a magnetic-permeability detection sensor, and detects the concentration of the toner existing in the developer.

Storage 33 includes: ROM (Read Only Memory) 33a configured to store control programs and control data for controlling the overall operation of printer 1 and performing the print processing; and RAM (Random Access Memory) 33b configured to temporarily store various types of information which are generated from the execution of the control programs. Incidentally, a rewritable flash ROM or the like is used as RAM 33b of the embodiment.

Main controller 34 includes a CPU (Central Processing Unit) 34a. Based on the control programs stored in ROM 33a, main controller 34 controls the overall operation of printer 1, and performs the print processing.

Manipulation input unit 35 includes: input devices, such as operation buttons, provided on an operation panel to receive input manipulations from the operator; and display devices, such as displays, provided on the operation panel.

The various sensors are a group of sensors including sheet position detection sensor 6, but excluding concentration sensors 29. Sheet position detection sensor 6 is configured to detect the position and orientation of each sheet P, as well as the amount of sheets P.

Using FIGS. 1 and 2, descriptions are hereinbelow provided for how printer 1 of the embodiment performs the printing processing.

Sheets P housed in sheet cassette 2 are sent out by hopping roller 4 separately on a one-by-one basis from sheet cassette 2 onto sheet transport path 3. Each sheet P is transported by transport rollers 5 to secondary transfer roller 18.

On the other hand, in each development device 8, photosensitive drum 23 rotates in the transport rotation direction (see the arrow illustrated in FIG. 2). After photosensitive drum is evenly charged by charge roller 24, the surface of photosensitive drum 23 is exposed to the light emitted from exposure head 22. Thereby, the electrostatic latent image is formed on the outer peripheral surface of photosensitive drum 23.

Meanwhile, the developer made of the toner and the carriers circulates between first and second transport screws 26a, 26b while being agitated by first and second transport screws 26a, 26b. While transported by first transport screw 26a, the developer is drawn up by the magnetic force of development sleeve 25 to the outer peripheral surface of development sleeve 25. The drawn-up developer forms the magnetic brushes in accordance with the magnetic flux concentration distributed on development sleeve 25. The magnetic brushes are restricted by layer formation blade 27 to have the certain length.

With development sleeve 25 rotating in a direction reverse to the transport rotation direction, the magnetic brushes formed of the developer and restricted to have the certain length reach facing portions of development sleeve 25 and photosensitive drum 23. The negatively charged toner moves from development sleeve 25 onto the electrostatic latent image formed on photosensitive drum 23, and thereby forms the toner image on photosensitive drum 23.

It should be noted that the developer already passing through the facing portions of development sleeve 25 and photosensitive drum 23 (that is to say, the toner and the carriers not moving to photosensitive drum 23) is returned to first transport screw 26a and collected into development device 8 by the magnetic force distributed to become farther from development sleeve 25.

Meanwhile, the toner image formed on photosensitive drum 23 is transferred by primary transfer roller 17 onto intermediate transfer belt 15. Thereafter, the toner image is transported to secondary transfer roller 18, and is transferred by secondary transfer roller 18 onto sheet P which is being transported along sheet transport path 3.

The toner image transferred onto sheet P is heated and pressed by fixation unit 10 to be fixed onto sheet P. Sheet P onto which the toner image is fixed is delivered by delivery rollers 12 onto stacker 11.

In this way, printer 1 of the embodiment performs the printing processing.

The developer made of the toner and the carriers and used for the print processing is tested to evaluate how softening temperature T_{1/2} of the toner in a ½ method test (hereinafter referred to simply as “softening temperature T_{1/2}”) and surface free energy Ec of the resin coating layers of the carriers influence the adhesion of the toner to the carriers during the printing by printer 1.

The toner used for the evaluation is powder with a particle size of 5.5 μm made of: a polyester binder resin; a charge control agent as an internal additive; a release agent as an internal additive; a colorant as an internal additive; and wax and the like as external additives. The following six types of toners are used for the test.
Toner 1: softening temperature T_{1/2}=96° C.
Toner 2: softening temperature T_{1/2}=106° C.
Toner 3: softening temperature T_{1/2}=112° C.
Toner 4: softening temperature T_{1/2}=115° C.
Toner 5: softening temperature T_{1/2}=126° C.
Toner 6: softening temperature T_{1/2}=130° C.

It should be noted that a flow tester with a piston diameter of 1 mm (CFT-500D manufactured by Shimadzu Corporation) is used to measure softening temperature T_{1/2}. The measurement is carried out while recording a change in a piston stroke S in accordance with a rise in temperature under a condition in which a rate of increase in the atmosphere temperature of each sample is set at 3° C./min, and a load applied to the piston is set at 10 kg.

Softening temperature T_{1/2} of this case is defined as a temperature at a time when the piston reaches a mid-point stroke S_{1/2} expressed as

S_{1/2}=(Smin+Smax)/2

where: Smin denotes a stroke measured with the flow tester at a time when the toner starts to flow out; and Smax denotes a stroke measured with the flow tester at a time when all the toner has flown out of the cylinder.

The carriers used for the evaluation are globes with an average particle size of 35 μm each obtained by forming a resin coating layer on the outer surface of a globular core made of a magnetic material. The following four types of carriers produced by Powdertech Co., Ltd. are used for the test.
Carrier 1: Type EF592-35 (resin coating layer: fluorosilicone-based resin)
Carrier 2: Type EF96F-35 (resin coating layer: resin obtained by blending fluorine and silicone)
Carrier 3: Type EF96-35 (resin coating layer: silicone-based resin)
Carrier 4: Type EF83-35 (resin coating layer: acryl-based resin)

The surface free energy Ec of the surface of each of Carriers 1 to 4 is calculated using three solvents having their respective different already-known surface free energies, and an angle θ of contact of each solvent with a base plate made of the same material as the resin coating layers of each respective Carrier.

To put it concretely, the surface free energy E of a solvent and the angle θ of contact of the solvent with the base plate are expressed as (E1, θ1), (E2, θ2) and (E3, θ3) for Solvents 1, 2 and 3, respectively. A regression line of the three surface free energies E on the cosine cos θ of the contact angle θ can be obtained from

cos θ=a₁E+a₀

and a₁ and a₀ are determined as below:

$$\begin{matrix}[ Formula 1 ] & \\ {a}_{1} = \frac{{\sum }_{i = 1}^{3} ( {E}_{i} - \overline{E} ) ( cos {θ}_{i} - \overline{cos θ} )}{{\sum }_{i = 1}^{3} {( {E}_{i} - \overline{E} )}^{2}} & ( 1 ) \\ {a}_{0} = \overline{cos θ} - {a}_{1} \overline{E} \\ where \\ \overline{E} = \frac{{\sum }_{i = 1}^{3} {E}_{i}}{3} , \\ \overline{cos θ} = \frac{{\sum }_{i = 1}^{3} cos {θ}_{i}}{3} . & ( 2 )\end{matrix}$$

The surface free energy E at a time when cos θ=1 is the surface free energy Ec of the base plate (resin coating layer) intended to be obtained. For this reason, the surface free energy Ec of each base plate can be obtained from:

$$\begin{matrix}[ Formula 2 ] & \\ {E}_{c} = \frac{1 - {a}_{0}}{{a}_{1}} . & ( 3 )\end{matrix}$$

In the embodiment, the three solvents are Solvent 1 (water), Solvent 2 (1-Bromonaphtalene) and Solvent 3 (n-Dodecane). The angle θ of contact of each solvent with each base plate is measured using an automatic contact angle meter (CA-V manufactured by Kyowa Interface Science Co., Ltd.). The surface free energy Ec of the surface of each of Carriers 1 to 4 is calculated using the afore-mentioned Equations (1), (2) and (3).

The thus-calculated surface free energy Ec of the surface of Carrier 1 is equal to 12 mN/m (millinewton/meter); Carrier 2, is 15 mN/m; Carrier 3, is 20 mN/m; and Carrier 4, is 40 mN/m.

Developers with a toner concentration of 10% are prepared by combining each of the afore-mentioned six toners and each of the afore-mentioned four types of Carriers. Each thus-prepared developer is filled into development device 8 of printer 1, and printing is performed on 10000 sheets using the developer. For each developer, after the printing, it is evaluated whether or not the carriers adhere to the toner. The conditions for the evaluation are as follows.

Sheets P: A-4 standard sheets (for example, OKI Excellent White sheets with a basis weight of 80 g/m²)

Printing speed (=speed in the circumferential direction of photosensitive drum 23=transport speed): 200 mm/s

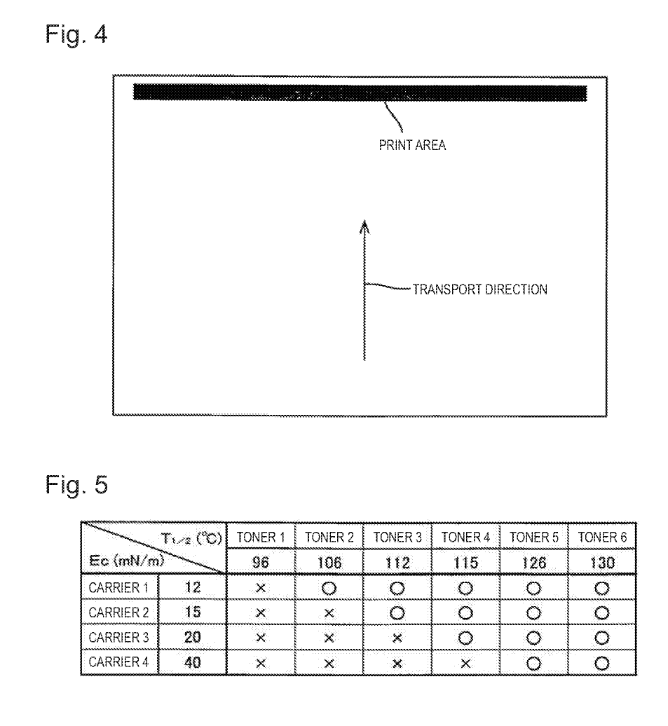

Transport direction of sheets P: transport in the transverse direction (transport in a direction of the short side of each sheet P, see FIG. 4)

Print pattern: 5-percent duty (against 100-percent duty which is defined as printing with an area ratio of 100% at a time when solid printing is performed on all the printable area of each sheet P)

It should be noted that in the evaluation test, the charge voltage to be applied to charge roller 24 is fixed at −1146 V which makes the surface potential of photosensitive drum 23 equal to −600 V; the amount of light emitted from exposure head 22 is adjusted to make the potential of each latent image on photosensitive drum 23 equal to −100 V during the exposure; and a voltage of −500 V is applied to each of development sleeve 25 and layer formation blade 27.

Furthermore, as illustrated in FIG. 4, the print pattern is a pattern in which black solid printing is performed on a print area with an area ratio of 5% provided on the leading edge side of each sheet P in the transport direction and extending in a direction orthogonal to the transport direction.

FIG. 5 illustrates a result of the evaluation performed under the afore-mentioned evaluation conditions. Incidentally, each evaluation judgment is indicated with either “x” or “o”. “x” represents the case where the toner adheres to the carriers and defects accordingly occur to the printed images. “o” represents the case where no toner adheres to the carriers and excellent printed images are obtained.

The followings are learned from FIG. 5.

(a) In the case of a toner with softening temperature T_{1/2} of 96° C., the toner adheres to the carriers no matter which of Carriers 1 to 4 is used.

(b) In the case of a toner with softening temperature T_{1/2} of 106° C., the toner does not adhere to the carriers when the carriers whose resin coating layers have a surface free energy Ec of 12 mN/m or less are used.

(c) In the case of a toner with softening temperature T_{1/2} of 112° C., the toner does not adheres to the carriers when the carriers whose resin coating layers have a surface free energy Ec of 15 mN/m or less are used.

(d) In the case of a toner with softening temperature T_{1/2} of 115° C., the toner does not adheres to the carriers when the carriers whose resin coating layers have a surface free energy Ec of 20 mN/m or less are used.

(e) In the case of a toner with softening temperature T_{1/2} of 126° C., the toner does not adheres to the carriers when the carriers whose resin coating layers have a surface free energy Ec of 40 mN/m or less are used.

(f) In the case of a toner with softening temperature T_{1/2} of 130° C., the toner does not adheres to the carriers when the carriers whose resin coating layers have a surface free energy Ec of 40 mN/m or less are used.

One may consider that this is because: in the case of a toner whose softening temperature T_{1/2} is lower, the surface free energy of the resin coating layers of the carriers becomes larger, that is to say, the area of contact between the resin coating layers of the carriers and the toner becomes larger; thus, frictional force becomes larger between the resin coating layers of the carriers and the toner, and a larger amount of frictional heat occurs. Accordingly, the toner becomes easier to melt and adhere to the carriers.

In this case, the lower and upper limits of the surface free energy Ec of the resin coating layers of the carriers are 12 mN/m and 40 mN/m, respectively. This is because: if the surface free energy Ec of the resin coating layers is less than the lower limit, the amount of charge on the toner becomes too large, and the printed images deteriorate; and if the surface free energy Ec of the resin coating layers is greater than the upper limit, the toner becomes less likely to be charged, and the printed images deteriorate.

Furthermore, the lower and upper limits of softening temperature T_{1/2} of the toner are 106° C. and 130° C., respectively. This is because: if softening temperature T_{1/2} of the toner is less than the lower limit, the toner becomes easier to melt as described above, and the resultant adhesion of the toner to the carriers makes the printed images deteriorate; and if softening temperature T_{1/2} of the toner is greater than the upper limit, defects occur to the fixing of the toner images by fixation unit 10, and the print quality becomes worse.

With the above-discussed points taken into consideration, the toner can be inhibited from adhering to the carriers by:

(1) using the carriers whose resin coating layers have a surface free energy Ec of 12 mN/m in a case where softening temperature T_{1/2} of the toner is not less than 106° C. but is less than 112° C.;

(2) using the carriers whose resin coating layers have a surface free energy Ec of 15 mN/m or less in a case where softening temperature T_{1/2} of the toner is not less than 112° C. but is less than 115° C.;

(3) using the carriers whose resin coating layers have a surface free energy Ec of 20 mN/m or less in a case where softening temperature T_{1/2} of the toner is not less than 115° C. but is less than 126° C.; and

(4) using the carriers whose resin coating layers have a surface free energy Ec of 40 mN/m or less in a case where softening temperature T_{1/2} of the toner is not less than 126° C. but is not greater than 130° C.

In the embodiment, if as described above, the toner whose softening temperature T_{1/2} is within the range of not less than 106° C. to not greater than 130° C., and the carriers whose resin coating layers have a surface free energy Ec of not less than 12 mN/m but not greater than 40 mN/m are used in combination, the surface free energy Ec of the resin coating layers of the carriers to be filled in advance is changed depending on temperature T_{1/2} of the toner. For this reason, the embodiment can prevent deterioration in the printed images due to the amount of charge on the toner, which would have become unstable if the negatively-charged toner had adhered to the positively-charged carriers, and can obtain high-quality printed images.

It should be noted that although the foregoing embodiment is described in which the image formation apparatus is the printer, the image formation apparatus is not limited to what is described above, and may be a copy machine, a facsimile machine or a multi-function printer (MFP).

The invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

What is claimed is:

1. A two-component developer comprising:
a toner; and
carriers, wherein
a softening temperature of the toner in a ½ method test is not less than 106° C. but is less than 112° C., and surface free energy of resin coating layers of the carriers is set at 12 mN/m,
the softening temperature of the toner in the ½ method test is not less than 112° C. but is less than 115° C., and the surface free energy of the resin coating layers of the carriers is set at not greater than 15 mN/m,
the softening temperature of the toner in the ½ method test is not less than 115° C. but is less than 126° C., and the surface free energy of the resin coating layers of the carriers is set at not greater than 20 mN/m, or
the softening temperature of the toner in the ½ method test is not less than 126° C. but not greater than 130° C., and the surface free energy of the resin coating layers of the carriers is set at not greater than 40 mN/m.

2. The two-component developer according to claim 1, wherein lower and upper limits of the softening temperature of the toner in the ½ method test are 106° C. and 130° C., respectively, and
lower and upper limits of the surface free energy of the resin coating layers of the carriers are 12 mN/m and 40 mN/m, respectively.

3. A development device comprising:
the two-component developer according to claim 1;
an image carrier;
a charge member configured to charge a surface of the image carrier; and
a development member configured to make the toner adhere to an electrostatic latent image on the image carrier and thereby forming a toner image on the image carrier.

4. The development device according to claim 3,
further comprising first and second transport screws configured to transport the two-component developer while agitating the two-component developer, wherein
the first transport screw is placed opposite to the development member, and
the second transport screw and the first transport screw are placed next to each other across a projection wall.

5. An image formation apparatus comprising the development device according to claim 3.

6. An image formation apparatus comprising the development device according to claim 4.

7. A two-component developer comprising:
a toner; and
carriers, wherein
lower and upper limits of a softening temperature of the toner in the ½ method test are 106° C. and 130° C., respectively, and
lower and upper limits of a surface free energy of resin coating layers of the carriers are 12 mN/m and 40 mN/m, respectively.

8. The two-component developer according to claim 7, wherein
the softening temperature of the toner in a ½ method test is not less than 106° C. but is less than 112° C., and
the surface free energy of the resin coating layers of the carriers is 12 mN/m.

9. The two-component developer according to claim 7, wherein
the softening temperature of the toner in the ½ method test is not less than 112° C. but is less than 115° C., and
the surface free energy of the resin coating layers of the carriers is not less than 12 mN/m and not greater than 15 mN/m.

10. The two-component developer according to claim 7, wherein
the softening temperature of the toner in the ½ method test is not less than 115° C. but is less than 126° C., and
the surface free energy of the resin coating layers of the carriers is not less than 12 mN/m and greater than 20 mN/m.

11. The two-component developer according to claim 7, wherein
the softening temperature of the toner in the ½ method test is not less than 126° C. but not greater than 130° C., and
the surface free energy of the resin coating layers of the carriers is not less than 12 mN/m and not greater than 40 mN/m.
